(19) United States
(12) Patent Application Publication
(10) Pub. No.: US 2007/0222835 A1
(43) Pub. Date: Sep. 27, 2007

(54) Ink cartridge

(76) Inventor: Pui-Kuong Lui, Kowloon (HK)

Correspondence Address: ROSENBERG, KLEIN & LEE, 3458 ELLICOTT CENTER DRIVE-SUITE 101, ELLICOTT CITY, MD, 21043, US

(21) Appl. No.: 11/389,195

(22) Filed: Mar. 27, 2006

(51) Int. Cl. B41J 2/175

(52) U.S. Cl. 347/86

(57) ABSTRACT

An ink cartridge includes a hollow ink tank body, a cover connected to a top of the hollow ink tank body; a pressure regulator arranged inside the hollow ink tank body, and a sealing ring enclosing a supply port of the hollow ink tank body. The hollow ink tank body defines a chamber therein, and the supply port is formed on a bottom thereof. The cover has an air vent penetrating therethrough and a handling member pivoted to a top surface thereof and rotatable for manipulation. The pressure regulator is connected to a hollow tube communicating with the air vent of the cover, so that atmospheric air passes through the pressure regulator via the hollow tube after a sealing film is removed. The sealing ring is made of elastic material to ease for penetration with a small aperture that can be shrunk to secure ink flow from the supply port.

### BACKGROUND OF THE INVENTION

1. Field of the Invention

The present invention relates to an ink cartridge adapted for an ink-jet recording apparatus, and particularly relates to a replaceable ink cartridge having an improved structure that can be taken out with simple steps and prevent the ink leakage problem from an outlet thereof.

2. Description of Related Art

An ink-jet recording apparatus is usually equipped with an ink-jet recording head which is mounted on a carriage and moved in the widthwise direction of recording paper, and paper feed means for moving the recording paper in the direction orthogonal to the traveling direction of the recording head. On the basis of print data, ink droplets are ejected from the recording head, thus recording the data on the recording paper. The recording head is mounted on the carriage, and is capable of ejecting ink droplets of, for example, black, yellow, cyan, magenta, etc. Accordingly, the ink-jet recording apparatus enables full-color printing by changing the proportions of ink types, as well as effecting text printing with black ink. Incidentally, in order to replace the exhausted cartridge, there has been provided a specific mechanism that can lift the cartridge for being taken out. To this end, U.S. Publication No. 2002/0085075 A1, entitled “Ink Cartridge For Ink-Jet Recording Apparatus”, discloses a lever with a projection that can be manipulated to lift an ink cartridge for replacement. But, alternative mechanism can be further explored to adequately address this issue. The above-mentioned reference further provides a double-sided printed circuit board that disposes with contacts and a storage member on opposite surfaces, respectively. However, the double-sided printed circuit board is more expensive than a single-sided one, and there may be one solution for decreasing the cost of the printed circuit board.

Furthermore, ink leakage problems of the ink cartridge are always the topic, especially during storage, delivery, etc, and particularly to meet low-cost requirements.

It is desirable to develop a new chip and improved ink cartridge to substantially resolve the mentioned problems and provide better, more advantageous overall results.

### SUMMARY OF THE INVENTION

An ink cartridge adapted for an ink-jet recording apparatus is provided for being taken out easily for ink replacement.

The ink cartridge adapted for the ink-jet recording apparatus is provided with a sealing ring for preventing leakage problems from delivery and storage, avoiding external resistance breaking a supply port thereof, and is cost-effective at the same time.

The ink cartridge adapted for the ink-jet recording apparatus is provided with a single-sided circuit board that can save the costs.

The ink cartridge adapted for the ink-jet recording apparatus is further provided with a removable clip for avoiding an ink tank crashed and accidental leakage.

An ink cartridge includes a hollow ink tank body, a cover connected to a top of the hollow ink tank body; a pressure regulator arranged inside the hollow ink tank body, and a sealing ring enclosing a supply port of the hollow ink tank body. The hollow ink tank body defines a chamber therein, and the supply port is formed on a bottom thereof. The cover has an air vent penetrating therethrough and a handling member pivoted to a top surface thereof and rotatable for manipulation. The pressure regulator is connected to a hollow tube communicating with the air vent of the cover, so that atmospheric air passes through the pressure regulator via the hollow tube after a sealing film is removed. The sealing ring is made of elastic material to ease for penetration with a small aperture that is made by a needle and shrunk to secure ink flow from the supply port. The ink cartridge further includes a single-sided printed circuit board disposed at a front of the hollow ink tank body, and has a plurality of contact pads and a memory member formed on a front surface thereof, and the memory member is projected from the front surface. The ink cartridge further includes a clip of an L shape engaged with the hollow ink tank body, the clip includes a vertical portion and a horizontal portion having an end connecting the vertical portion, the horizontal portion has an up-straight wall extending from an opposite end thereof; the supply port of the hollow ink tank body abuts against the horizontal portion, and received between the vertical portion and the up-straight wall.

To provide a further understanding of the invention, the following detailed description illustrates embodiments and examples of the invention. Examples of the more important features of the invention have thus been summarized rather broadly in order that the detailed description thereof that follows may be better understood, and in order that the contributions to the art may be appreciated. There are, of course, additional features of the invention that will be described hereinafter which will form the subject of the claims appended hereto.

### BRIEF DESCRIPTION OF THE DRAWINGS

These and other features, aspects, and advantages of the present invention will become better understood with regard to the following description, appended claims, and accompanying drawings, where:

FIG. 1 is a decomposition view of an ink cartridge according to the present invention;

FIG. 2 is a decomposition view of another embodiment of a handling member of the ink cartridge according to the present invention;

FIG. 3 is a perspective view of another embodiment of the ink cartridge according to the present invention;

FIG. 4A is a top view of a printed circuit board of the ink cartridge according to the present invention;

FIG. 4B is a side view of the printed circuit board of the ink cartridge according to the present invention;

FIG. 4C is a top view of an embodiment of the arrangement of contact pads of the printed circuit board of the ink cartridge according to the present invention;

FIG. 4D is a top view of another embodiment of the arrangement of contact pads of the printed circuit board of the ink cartridge according to the present invention;

FIG. 4E is a top view of an additional embodiment of the arrangement of contact pads of the printed circuit board of the ink cartridge according to the present invention;

FIG. 5A is a perspective view of a first embodiment of a sealing ring of the ink cartridge according to the present invention;

FIG. 5B is a cross-sectional profile of the first embodiment of the sealing ring of the ink cartridge according to the present invention;

FIG. 6A is a perspective view of a second embodiment of a sealing ring of the ink cartridge according to the present invention;

FIG. 6B is a cross-sectional profile of the second embodiment of the sealing ring of the ink cartridge according to the present invention;

FIG. 7A is a perspective view of a third embodiment of the sealing ring of the ink cartridge according to the present invention;

FIG. 7B is a cross-sectional profile of the third embodiment of the sealing ring of the ink cartridge according to the present invention; and

FIG. 8 is a perspective view of the handling member of the ink cartridge according to the present invention.

### DETAILED DESCRIPTION OF PREFERRED EMBODIMENTS

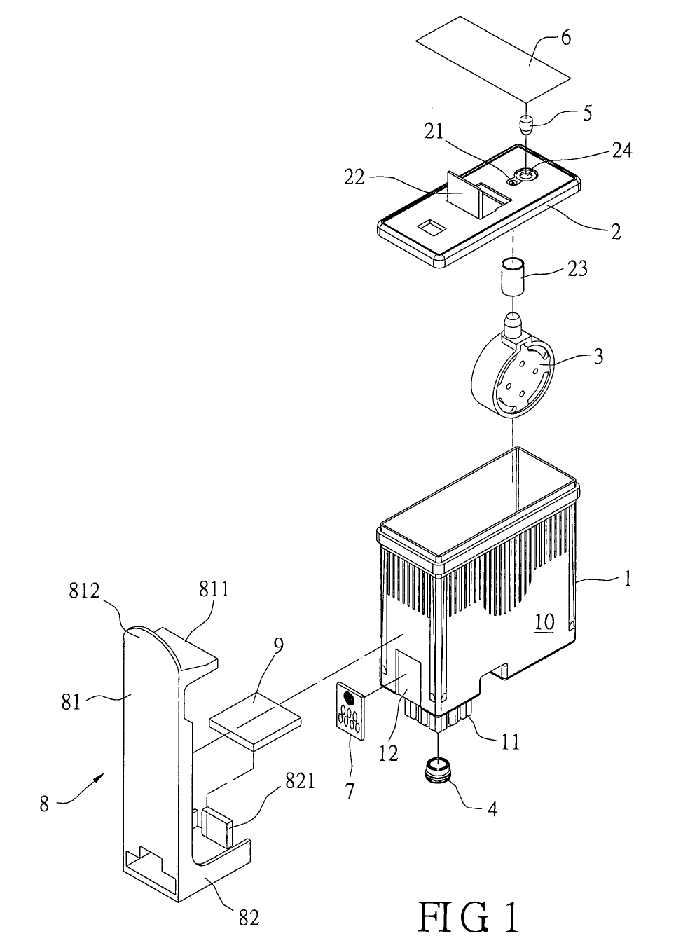

Referring to FIG. 1, an ink cartridge according to a preferred embodiment according to the present invention includes a hollow ink tank body 1, a cover 2 connected to a top of the hollow ink tank body 1, a pressure regulator 3 arranged inside the hollow ink tank body 1, a sealing ring 4 enclosing a supply port 11 of the hollow ink tank body 1, and a rubber stuff 5 that can be used to enclose an ink inlet 24 formed through the cover 2 after a sealing film 6 is removed. The hollow ink tank body 1 defines a chamber 10 therein filled with ink, and the supply port 11 is formed on a bottom thereof for delivering the ink outwards. The cover 2 has a body 20 and an air vent 21 penetrating through the body 20, and a handling member 22 pivoted to a top surface of the body 20 for being rotatable for manipulation. The pressure regulator 3 is connected to a hollow tube 23 communicating with the air vent 21 of the cover 2, so that atmospheric air passes through the pressure regulator 3 via the hollow tube 23 after the sealing film 6 is removed. The sealing ring 4 is made of elastic material to ease for penetration with a small aperture (not shown) that is made by a needle and shrunk to secure ink flow from the supply port 11.

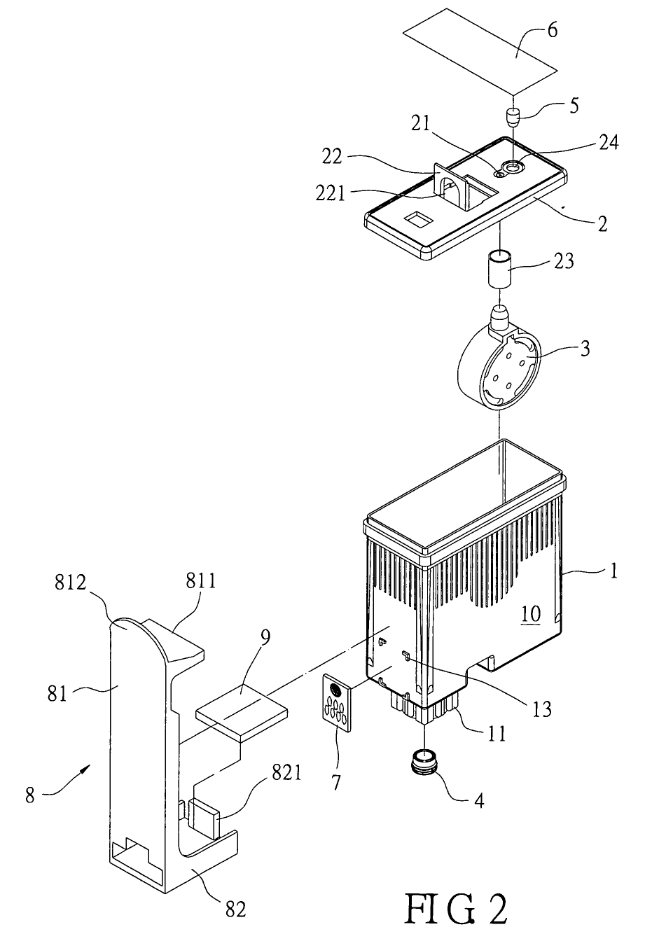

The cover 2, illustrated in FIG. 8, has a recess 25 formed on the top surface of the body 20 thereof, and the handling member 22 is deposited and pivoted inside the recess 25; the cover 2 has a retaining block 26 disposed inside the recess 25 and adjacent to a side of the recess 25 to connect with the body 20. A length of the handling member 22 is shorter than that of the recess 25, and the handling member 22 has a cutout 222 mating with and abutting against the retaining block 26, so that the user can touch the retaining block 26 first, force the handling member 22 with some external sideway resistance, then the handling member 22 can be rotated to lift, and finally the handling member 22 can be manipulated to draw out the ink tank body easily. With respect to FIGS. 1 and 2, the handling member 22 can be real (in FIG. 1) or has an opening 221 formed therethrough (in FIG. 2).

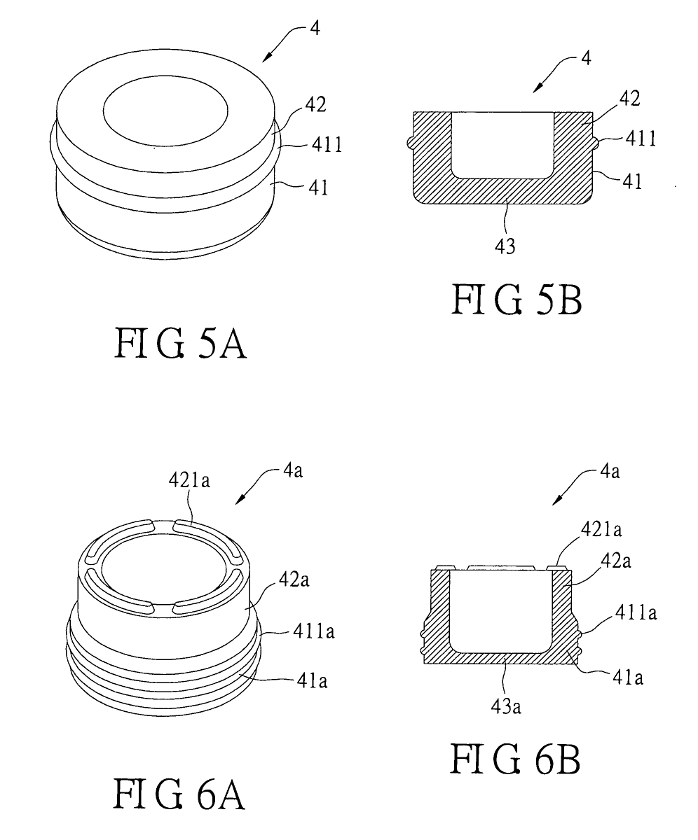

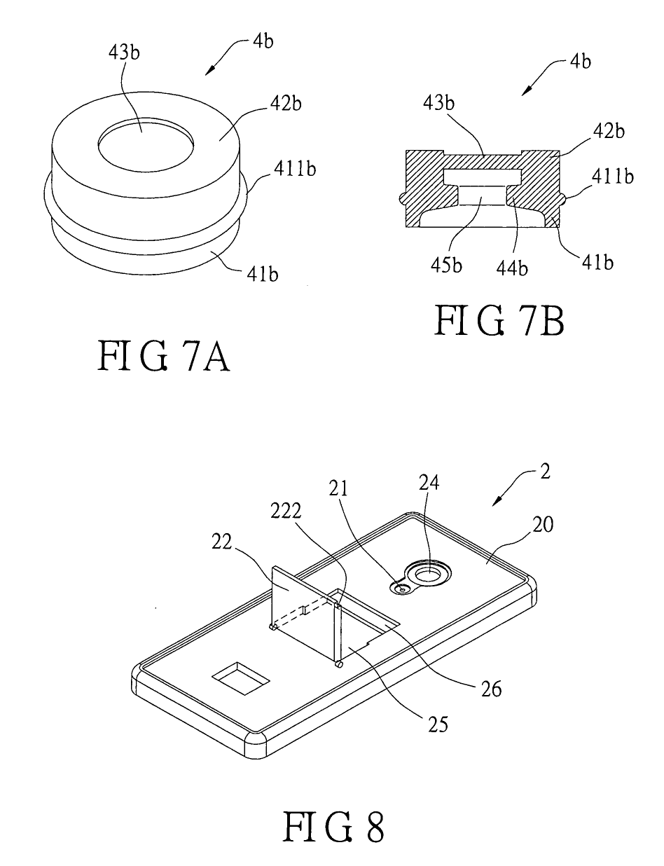

A sealing film applied to conventional ink cartridge usually is made of polymer or/and laminated metal layer is/are used to seal the conventional supply port to prevent the ink leakage. Instead, the ink cartridge according to the present invention discloses the sealing ring 4, which is pre-formed with a small aperture to ease for penetration by a needle. Referring to FIGS. 5A to 5B, the sealing ring 4 includes a cap 41 that has at least one annular projection 411 extended outwardly therefrom to abut against the supply port 11, a hollow pillar 42 connecting the cap 41, and a sealing plate 43 connected to a bottom of the cap 41. Illustrated in FIGS. 6A to 6B, another embodiment of the sealing is disclosed, a sealing ring 4a includes a cap 41a that has a plurality of annular projections 411a extended outwardly therefrom, a hollow pillar 42a connecting the cap 41a, and a sealing plate 43a connected to a bottom of the cap 41a. The annular projections 411a provides much security to mount to the supply port 11. In this embodiment, the cap 41a has an exterior radius larger than that of the pillar 42a, so that the sealing ring 4a inserts into the supply port 11 via the hollow pillar 42a and engages with the supply port 11 via the annular projection 411 a of the cap 41a. In addition, the sealing ring 4a has at least one bump 421 a upwardly protruding from a top surface of the hollow pillar 42a to retain against a corresponding portion (not shown) of the supply port 11. Illustrated in FIGS. 7A to 7B, additional embodiment of the sealing is disclosed, a sealing ring 4b includes a cap 41b that has a plurality of annular projections 411b extended outwardly therefrom, a hollow pillar 42b connecting the cap 41b, and a sealing plate 43b connecting to a top of the hollow pillar 42b. The annular projections 411b provides much security to mount to the supply port 11. The sealing ring 4b further includes a budge 44b extended inwardly therefrom in order to form a choke 45b existed therein. The choke 45b can narrow the ink flowing out from the supply port 11 effectively.

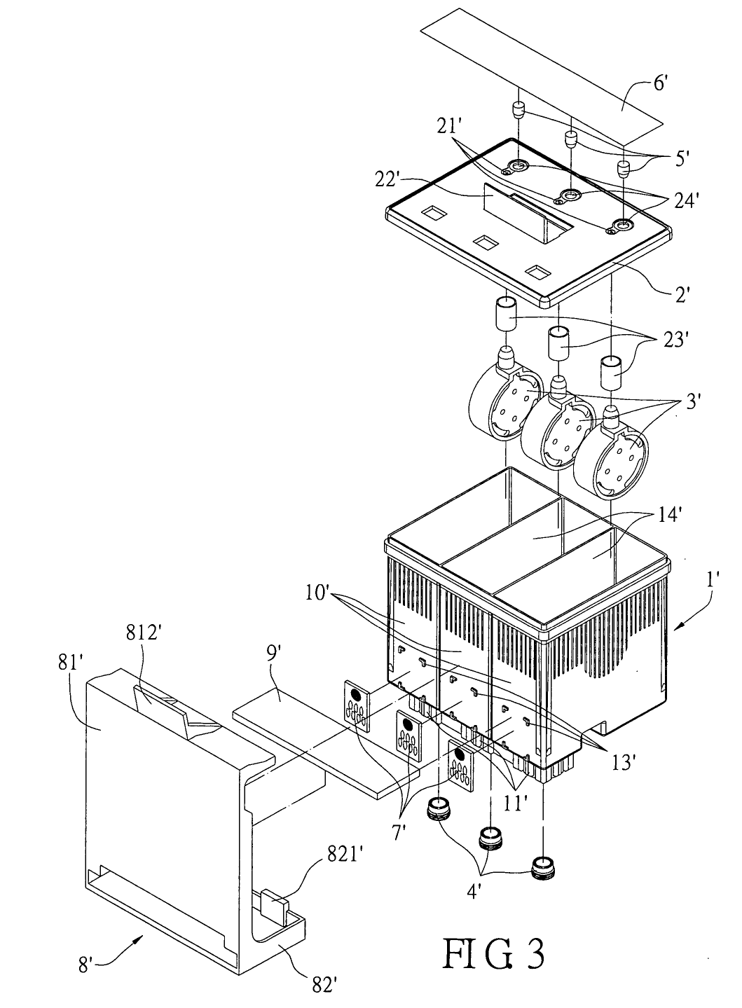

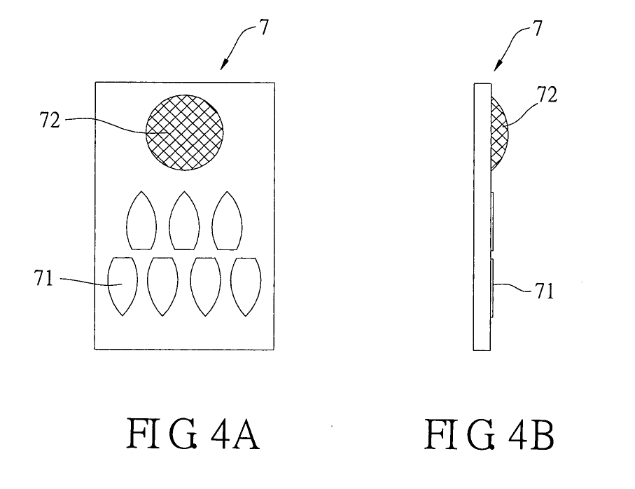

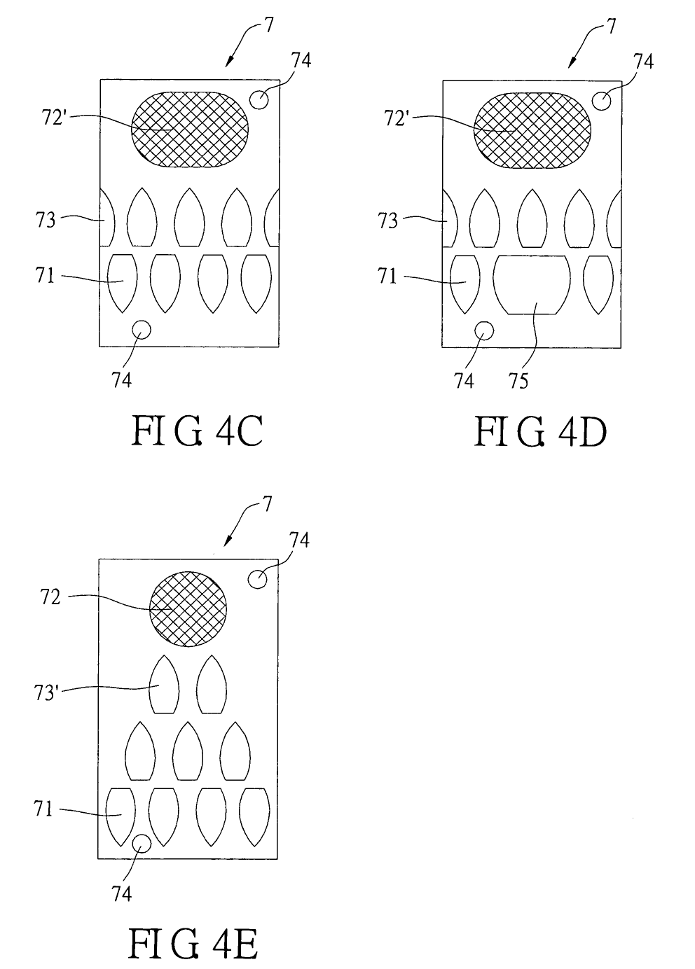

With respect to FIGS. 1, 4A and 4B, the ink cartridge further includes a single-sided printed circuit board 7 disposed at a front of the hollow ink tank body 1, and has a plurality of contact pads 71 and a memory member 72 formed on a front surface thereof, wherein the memory member 72 is projected from the front surface of the single-sided printed circuit board 7. Thus, the hollow ink tank body 1 has a depression 12 formed at the front thereof for receiving the single-sided printed circuit board 7 via an adhesive tape (not shown). The projected memory member 72 is placed on the same face with the contact pads 71 so that the single-sided board could be made. The contact pads 71 are arranged into two rows in an alternate manner, each has a predetermined configuration that is leaf-like.

With respect to FIG. 2, another embodiment of the arrangement of the single-sided printed circuit board 7 is provided. The hollow ink tank body 1 has a plurality of L-shaped frames 13 arranged at predetermined portions corresponding with the corners of the single-sided printed circuit board 7. Thus, the single-sided printed circuit board 7 can be embedded by L-shaped frames 13 for further secure.

In addition, FIGS. 4C to 4E illustrate various arrangements of pads. Referring to FIG. 4C, two additional test pads 73 are half single contact pad 71 and disposed at two lateral edges of the single-sided printed circuit board 7 respectively. The additional test pads 73 are adjacent to a first row of the contact pads 71 symmetrically. These additional test pads 73 are testing points for testing chip data by a testing device (not shown) to guarantee the chip data accuracy before attached to the cartridge, not connecting to contacts of the printer but only for testing device use. In addition, the single-sided printed circuit board 7 has at least two production-guiding holes 74 located at two predetermined areas thereof. One of the production-guiding holes 74 is adjacent to the projected memory member 72 and at a corner of the single-sided printed circuit board 7. The other is opposite to the prior one and disposed between the edgiest two contact pads 71 of the second row. The production-guiding holes 74 are used for guiding the circuit board layout production within controllable dimension to minimize the displacement error, and used in guiding purpose during the chip production process. Referring to FIG. 4D, two middle contact pads 71 of a second row thereof are replaced by an enlarged contact pad 75. Referring to FIG. 4E, the additional whole test pads 73′ are disposed above the first row of the contact pads 71 and arranged symmetrically. With respect to FIGS. 4A, 4B and FIG. 4E, the projected memory member 72 can be an annular; in FIGS. 4C and 4D, a projected memory member 72′ which is oval-shaped is instead of the annular projected memory member 72.

Illustrated in FIG. 1, the ink cartridge further includes a clip 8 of an L shape engaged with the hollow ink tank body 1. The clip 8 includes a vertical portion 81 and a horizontal portion 82 having an end connecting the vertical portion 81. The horizontal portion 82 has an up-straight wall 821 extending from an opposite end thereof; thus the supply port 11 of the hollow ink tank body 1 abuts against the horizontal portion 82, and received between the vertical portion 81 and the up-straight wall 821. The vertical portion 81 of the clip 8 has a clamping member 811 extending forwards the hollow ink tank body 1 to retain against the cover 2, so that the hollow ink tank body 1 and the cover 2 are engaged by the clamping member 811 of the vertical portion 81 and the horizontal portion 82 together. The vertical portion 81 further has a tab 812 connected a free end thereof to ease for operation, and the configuration of the tab 812 is not restricted. In addition, the ink cartridge can further include a packing member 9 disposed on the horizontal portion 82, and sandwiched between the sealing ring 4 that stuffed the supply port 11 and the horizontal portion 82 together, so as to provide more secure structure than before.

With respect to FIG. 3, another embodiment of the ink cartridge according to the present invention is provided. A hollow ink tank body 1′ having a plurality of partitions 14′ and defining respective chambers 10′, and a plurality of supply ports 11′ formed on a bottom thereof and corresponding to the respective chambers 10′. A cover 2′ is connected to a top of the hollow ink tank body 1′; and the cover 2′ has a plurality of air vents 21′ penetrating therethrough in accordance with the respective chambers 10′, and the handling member 22′ still remains single and pivoted to a top surface thereof, wherein the handling member 22′ is rotatable for manipulation. A plurality of pressure regulators 3′ are arranged inside the respective chambers 10′ of the hollow ink tank body 1′ and connected to respective hollow tubes 23′ that communicate with the air vents 21′ respectively, so that atmospheric air passes through the pressure regulators 3′ via the hollow tubes 23′ respectively after an elongated sealing film 6′ is removed. A plurality of sealing rings 4′ enclose the supply ports 11′ of the hollow ink tank body 1′ correspondingly, each of the sealing rings 4′ is made of elastic material to ease for penetration with a small aperture that is made by a needle and shrunk to secure ink flow from a corresponding one of the supply ports 11′. An elongated clip 8′ is along the hollow ink tank body 1′, and includes a vertical portion 81 ′ and a horizontal portion 82′. The horizontal portion 82′ has a plurality of up-straight walls 821′ extending therefrom. A plurality of single-sided printed circuit board 7′ can be embedded to the hollow ink tank body 1′, and each one is clamped via four L-shaped frames 13′. Furthermore, various applications are the same as the hollow ink tank body with one single chamber.

According to the present invention, the advantages of the ink cartridge are described as followed:

1. The pressure regulator provided in the ink cartridge is used for achieving the ink flow control and preventing the ink leakage problem effectively.

2. The pressure regulator provided in the ink cartridge saves the costs of sponge impregnated with ink by used a hollow ink tank instead.

3. The handling member is used to improve the handling problem, so that the user can easily take out the cartridge in a printer while ink replacement.

4. The sealing ring is used to secure the ink flow from the supply port, and also prevent the finger or external resistance from breaking the supply port. Furthermore, the sealing equipment cost is saved and hence to simplify the manufacturing process.

5. The removable clip is used to mount the ink cartridge to prevent being crashed and accidental leakage during delivery and storage.

6. The contact pads and the memory member are disposed at the same surface of the circuit board so as to save the material costs because double-sided circuit board is more expensive than single-sided one.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. An ink cartridge comprising:
a hollow ink tank body defining a chamber therein, and a supply port formed on a bottom thereof;
a cover connected to a top of the hollow ink tank body; wherein the cover has an air vent penetrating therethrough, and a handling member pivoted to a top surface thereof, wherein the handling member is rotatable for manipulation in order to take the ink cartridge out;
a pressure regulator arranged inside the chamber of the hollow ink tank body and connected to a hollow tube that communicates with the air vent of the cover, so that atmospheric air passes through the pressure regulator via the hollow tube after a sealing film is removed; and
a sealing ring enclosing the supply port of the hollow ink tank body, and made of elastic material to ease for penetration with a small aperture capable of being shrunk to secure ink flow from the supply port, wherein the sealing ring includes a cap that has at least one annular projection extended therefrom, and a hollow pillar connecting the cap.

2. The ink cartridge as claimed in claim 1, wherein the handling member is real or has an opening formed therethrough.

3. The ink cartridge as claimed in claim 1, wherein the cover has a recess formed on the top surface thereof, the handling member is deposited and pivoted inside the recess, and a length of the handling member is shorter than that of the recess.

4. The ink cartridge as claimed in claim 3, wherein the cover has a retaining block disposed inside the recess for retaining against the handling member, and the handling member has a cutout for mating with the retaining block of the cover.

5. The ink cartridge as claimed in claim 1, wherein the cap has an exterior radius larger than that of the pillar, so that the sealing ring inserts into the supply port via the hollow pillar and engages with the supply port via the annular projection of the cap.

6. The ink cartridge as claimed in claim 1, wherein the sealing ring has at least one bump upwardly protruding from a top surface of the hollow pillar to retain against a corresponding portion of the supply port.

7. The ink cartridge as claimed in claim 1, wherein the sealing ring has a budge extended inwardly therefrom in order to form a choke.

8. The ink cartridge as claimed in claim 1, further including a single-sided printed circuit board disposed at a front of the hollow ink tank body, and has a plurality of contact pads and a memory member formed on a front surface thereof, wherein the memory member is projected from the front surface.

9. The ink cartridge as claimed in claim 8, wherein the hollow ink tank body has a depression formed at the front thereof for being attached with the single-sided printed circuit board; or the hollow ink tank body includes a plurality of L-shaped frames arranged at predetermined portions corresponding with the corners of the single-sided printed circuit board for embedding the single-sided printed circuit board therein.

10. The ink cartridge as claimed in claim 8, wherein the single-sided printed circuit board includes two test pads which are half single contact pad, disposed at two lateral edges of the single-sided printed circuit board respectively, and adjacent to a first row of the contact pads symmetrically; or the single-sided printed circuit board includes two whole test pads disposed above a first row of the contact pads and arranged symmetrically.

11. The ink cartridge as claimed in claim 8, wherein two middle ones of a second row of the contact pads are replaced by an enlarged contact pad.

12. The ink cartridge as claimed in claim 8, wherein the single-sided printed circuit board has at least two production-guiding holes located at two predetermined areas thereof; one is adjacent to the projected memory member and at a corner of the single-sided printed circuit board, and the other is opposite to the prior one and disposed between the edgiest two contact pads of the second row.

13. The ink cartridge as claimed in claim 1, further including a clip of an L shape engaged with the hollow ink tank body, wherein the clip includes a vertical portion and a horizontal portion having an end connecting the vertical portion, the horizontal portion has an up-straight wall extending from an opposite end thereof; the supply port of the hollow ink tank body abuts against the horizontal portion, and received between the vertical portion and the up-straight wall.

14. The ink cartridge as claimed in claim 13, wherein the vertical portion of the clip has a clamping member extending forwards the hollow ink tank body to retain against the cover, so that the hollow ink tank body and the cover are engaged by the clamping member of the vertical portion and the horizontal portion together.

15. The ink cartridge as claimed in claim 13, further including a packing member disposed on the horizontal portion, and sandwiched between the sealing ring that stuffed the supply port and the horizontal portion.

16. An ink cartridge comprising:
a hollow ink tank body having a plurality of partitions and defining respective chambers, and a plurality of supply ports formed on a bottom thereof and corresponding to the respective chambers;
a cover connected to a top of the hollow ink tank body; wherein the cover has a plurality of air vents penetrating therethrough in accordance with the respective chambers, and a handling member pivoted to a top surface thereof, wherein the handling member is rotatable for manipulation;
a plurality of pressure regulators arranged inside the respective chambers of the hollow ink tank body and connected to respective hollow tubes that communicate with the air vents respectively, so that atmospheric air passes through the pressure regulators via the hollow tubes respectively after a sealing film is removed; and
a plurality of sealing rings enclosing the supply ports of the hollow ink tank body correspondingly, wherein each of the sealing rings is made of elastic material to ease for penetration with a small aperture that is shrunk to secure ink flow from a corresponding one of the supply ports, wherein each of the sealing rings includes a cap that has a least one annular projection extended therefrom, and a hollow pillar connecting the cap.

17. The ink cartridge as claimed in claim 16, wherein the handling member is real or has an opening formed therethrough.

18. The ink cartridge as claimed in claim 16, wherein the cover has a recess formed on the top surface thereof, the handling member is deposited and pivoted inside the recess, and a length of the handling member is shorter than that of the recess.

19. The ink cartridge as claimed in claim 18, wherein the cover has a retaining block disposed inside the recess for retaining against the handling member, and the handling member has a cutout for mating with the retaining block of the cover.

20. The ink cartridge as claimed in claim 16, wherein the cap has an exterior radius larger than that of the pillar, so that the sealing ring inserts into the supply port via the hollow pillar and engages with the supply port via the annular projection of the cap.

21. The ink cartridge as claimed in claim 16, wherein each of the sealing rings has at least one bump upwardly protruding from a top surface of the hollow pillar to retain against a corresponding portion of each supply port.

22. The ink cartridge as claimed in claim 16, wherein each of the sealing rings has a budge extended inwardly therefrom in order to form a choke.

23. The ink cartridge as claimed in claim 16, further including a plurality of single-sided printed circuit boards disposed at a front of the hollow ink tank body and in accordance with the respective chambers, and each circuit board has a plurality of contact pads and a memory member formed on a front surface thereof, wherein the memory member is projected from the front surface.

24. The ink cartridge as claimed in claim 23, wherein the hollow ink tank body has a plurality of depressions formed at the front thereof for being attached with the single-sided printed circuit boards respectively; alternatively, the hollow ink tank body includes a plurality of L-shaped frames arranged at predetermined portions corresponding with the corners of each single-sided printed circuit board for embedding the single-sided printed circuit boards, respectively.

25. The ink cartridge as claimed in claim 23, wherein each of the single-sided printed circuit board includes two test pads which are half single contact pad, disposed at two lateral edges of the single-sided printed circuit board respectively, and adjacent to a first row of the contact pads symmetrically; alternatively, each of the single-sided printed circuit board includes two whole test pads disposed above a first row of the contact pads and arranged symmetrically.

26. The ink cartridge as claimed in claim 23, wherein two middle ones of a second row of the contact pads arranged each single-sided printed circuit board are replaced by an enlarged contact pad.

27. The ink cartridge as claimed in claim 23, wherein each of the single-sided printed circuit board has at least two production-guiding holes located at two predetermined areas thereof; one is adjacent to the projected memory member and at a corner of the single-sided printed circuit board, and the other is opposite to the prior one and disposed between the edgiest two contact pads of the second row.

28. The ink cartridge as claimed in claim 16, further including a clip of an L shape engaged with the hollow ink tank body, wherein the clip includes a vertical portion and a horizontal portion having an end connecting the vertical portion; the horizontal portion has an up-straight wall extending from an opposite end thereof; each of the supply ports of the hollow ink tank body abuts against the horizontal portion, and received between the vertical portion and the up-straight wall.

29. The ink cartridge as claimed in claim 28, wherein the vertical portion of the clip has a clamping member extending forwards the hollow ink tank body to retain against the cover, so that the hollow ink tank body and the cover are engaged by the clamping member of the vertical portion and the horizontal portion together.

30. The ink cartridge as claimed in claim 28, further including a packing member disposed on the horizontal portion, and sandwiched between the sealing rings that stuffed the supply ports and the horizontal portion.
